(19) United States
(12) Patent Application Publication
(10) Pub. No.: US 2026/0180010 A1
(43) Pub. Date: Jun. 25, 2026

(54) POLYMERIC ALKALI METAL ALKOXIDES AND THIOLATES AS SOLID-STATE ELECTROLYTES AND SURFACE COATINGS IN RECHARGEABLE BATTERIES

(71) Applicant: BOARD OF TRUSTEES OF THE UNIVERSITY OF ARKANSAS, Fayetteville, AR (US)

(72) Inventors: Xiangbo Meng, Fayetteville, AR (US); Aiying Shao, Fayetteville, AR (US)

(73) Assignee: BOARD OF TRUSTEES OF THE UNIVERSITY OF ARKANSAS, Fayetteville, AR (US)

(21) Appl. No.: 19/121,420

(22) PCT Filed: Oct. 14, 2023
(86) PCT No.: PCT/US2023/035163

§ 371 Date: Apr. 15, 2025

Related U.S. Application Data
(60) Provisional application No. 63/416,799, filed on Oct. 17, 2022.

(51) Int. Cl. H01M 10/0525

(52) U.S. Cl. CPC H01M 10/0525

(57) ABSTRACT

Embodiments of the present disclosure pertain to an energy storage device with a polymeric composition that includes, without limitation, a metal alkoxide-based polymer, a homopolymer of a metal alkoxide-based polymer, a heteropolymer of a metal alkoxide-based polymer, a thiolate-based polymer, a homopolymer of a thiolate-based polymer, a heteropolymer of a thiolate-based polymer, and a heteropolymer of a metal alkoxide-based polymer and a thiolate-based polymer. Additional embodiments of the present disclosure pertain to methods of making the energy storage devices of the present disclosure. Further embodiments of the present disclosure pertain to the polymeric compositions and methods of forming them.

### CROSS-REFERENCE TO RELATED APPLICATIONS

This application claims priority to U.S. Provisional Patent Application No. 63/416,799, filed on Oct. 17, 2022. The entirety of the aforementioned application is incorporated herein by reference.

### BACKGROUND

A need exists for the development of improved energy storage device components that have at least improved ionic conductivity, enhanced interfaces, high Li⁺ transference number, and high electrochemical and thermal stability. Numerous embodiments of the present disclosure aim to address the aforementioned need.

### SUMMARY

In some embodiments, the present disclosure pertains to an energy storage device. In some embodiments, at least one component of the energy storage device is associated with a polymeric composition. In some embodiments, the polymeric composition includes at least one polymer. In some embodiments, the polymer includes, without limitation, a metal alkoxide-based polymer, a homopolymer of a metal alkoxide-based polymer, a heteropolymer of a metal alkoxide-based polymer, a thiolate-based polymer, a homopolymer of a thiolate-based polymer, a heteropolymer of a thiolate-based polymer, and a heteropolymer of a metal alkoxide-based polymer and a thiolate-based polymer.

Additional embodiments of the present disclosure pertain to methods of making an energy storage device. In some embodiments, the methods of the present disclosure generally include a step of forming a polymeric composition. In some embodiments, the methods of the present disclosure also include a step of incorporating the polymeric composition as a component of the energy storage device.

In some embodiments, polymeric compositions are formed by (1) combining at least one metal source with at least one hydroxyl group-containing organic precursor to form a metal alkoxide-based homopolymer or heteropolymer, (2) combining at least one metal source with at least one thiol group-containing organic precursor to form a thiolate-based homopolymer or heteropolymer, and/or (3) combining at least one metal source with at least one hydroxyl group-containing organic precursor and at least one thiol group-containing organic precursor to form a metal alkoxide-based and thiolate-based heteropolymer.

Various methods may be utilized to incorporate the formed polymeric compositions of the present disclosure into energy storage devices. For instance, in some embodiments, the incorporation includes forming the polymeric composition on a component of the energy storage device. In some embodiments, the incorporation includes associating the formed polymeric composition with a component of the energy storage device.

Additional embodiments of the present disclosure pertain to the polymeric compositions of the present disclosure. Further embodiments of the present disclosure pertain to methods of forming the polymeric compositions of the present disclosure.

### DESCRIPTION OF THE DRAWINGS

FIGS. 1A-1C provide depictions of batteries that contain the polymeric compositions of the present disclosure.

FIG. 2 provides structures of alkali metal precursors, which can serve as Li, Na, and K sources for the polymeric compositions of the present disclosure.

FIG. 3 provides structures of metal precursors other than alkali metal precursors, which can also serve as metal sources for the polymeric compositions of the present disclosure.

FIG. 4 provides structures of organic precursors featuring hydroxyl functional groups, including diols, triols, and polyols.

FIG. 5 provides structures of organic precursors featuring thiol functional groups, including dithiols, trithiols, and polythiols.

FIG. 6 provides a schematic illustration of a general molecular layer deposition (MLD) process for growing alkali metal homo-alkoxides using the alkali metal precursors and organic precursors of the present disclosure.

FIG. 7 provides a schematic illustration of a general MLD process for growing alkali metal homo-thiolates using the alkali metal precursors and organic precursors of the present disclosure.

FIG. 8 provides a schematic illustration of a general super-MLD process for growing alkali metal co-alkoxides through combining two or more sub-MLD processes of homo-alkoxides in this invention.

FIG. 9 provides a schematic illustration of a general super-MLD process for growing alkali metal co-thiolates through combining two or more sub-MLD processes of homo-thiolates of the present disclosure.

FIG. 10 provides a schematic illustration of a general super-MLD process for growing alkali metal co-alkoxides-thiolates through combining two or more sub-MLD processes of homo-alkoxides and homo-thiolates of the present disclosure.

FIG. 11 provides a schematic illustration of a general super-MLD process for growing metal-doped alkali metal co-alkoxides through combining two or more sub-MLD processes of alkali metal homo-alkoxides and metal homo-alkoxides of the present disclosure.

FIG. 12 provides a schematic illustration of a general super-MLD process for growing metal-doped alkali metal co-thiolates through combining two or more sub-MLD processes of alkali metal homo-thiolates and metal homo-thiolates of the present disclosure.

FIG. 13 provides a schematic illustration of a super-MLD process for growing Al-doped LiGL through combining two sub-MLD processes of LiGL and AlGL of the present disclosure.

FIGS. 14A-14C provide data related to the mass growth of the super-MLD process of 1:1 LiGL-AlGL measured using quartz crystal microbalance (QCM). FIG. 14A shows the linear growth of 25 super-cycles of the super-MLD process of 1:1 LiGL-AlGL. FIGS. 14B-14C show two enlarged growth periods to show one super-MLD cycle consisting of two sub-MLD cycles of LiGL and AlGL.

FIGS. 15A-15B show the mass growth of the super-MLD process of 1:1 LiGL-ZnGL measured using quartz crystal microbalance (QCM). FIG. 15A shows a schematic illustration of a super-MLD process for growing Zn-doped LiGL through combining two sub-MLD processes of LiGL and ZnGL in this invention. FIG. 15B shows the linear growth of 25 super-cycles of the super-MLD process of 1:1 LiGL-ZnGL measured by QCM.

FIG. 16 shows the effects of the 1:1 LiGL-AlGL coating on Li anodes in Li/Li symmetric cells. Compared to the bare Li/Li cell, all the 1:1 LiGL-AlGL coatings with 10, 20, and 30 super-cycles (i.e., 1:1 LiGL-AlGL-10/20/30) could significantly improve the stability of Li anodes for long-term cyclability.

FIGS. 17A-17B show the growth mechanism of molecular layer deposition (MLD) for pure polymers (FIG. 17A) and metal-based hybrid polymers (FIG. 17B).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Lithium-ion batteries (LIBs) have revolutionized lifestyles in many ways. The state-of-the-art LIBs are quickly approaching their limits in energy density while new better battery technologies are urgently needed to help achieve numerous pursuits, such as electric vehicles. To this end, conceptual battery systems have been proposed and are under intensive development. Such battery systems include next-generation LIBs using new anodes (e.g., silicon (Si)) and new cathodes (e.g., layered LiNiₓMn_{y}Co_{z}O₂ oxides), alkali metal batteries (AMBs) using alkali metals (i.e., lithium (Li), sodium (Na), and potassium (K)) as anodes, and solid-state batteries using solid-state electrolytes (SEs) in place of traditional nonaqueous organic liquid electrolytes (oLEs).

Li metal has the lowest negative electrochemical potential (−3.04 V versus the standard hydrogen electrode). Thus, Li metal can couple with many cathodes for various LMBs of higher energy density, such as lithium transition metal oxides (e.g., LiCoO₂, LiNiₓMn_{y}Co_{z}O₂, and LiMn₂O₄), LiFePO₄, oxygen (O₂), and sulfur (S).

As a consequence, there is an ever-growing interest in LMBs, ascribed to their high energy. However, Li has a limited reserve on earth. As alternatives, Na and K metals are pursued as anodes in AMBs, due to their abundance.

Using SEs to replace traditional oLEs results in solid-state LIBs and AMBs. While pursuing high energies, these new batteries are expected to provide more reliable safety, longer lifetime, and lower cost.

SEs are desirable in many aspects for developing new battery technologies. First, they may address some issues existing in battery cells with oLEs and make some new electrodes feasible, such as Si anodes and S cathodes. Both Si and S feature their cost-effectiveness and high capacity. In oLEs, Si suffers from large volume change up to 400% and many issues incurred by the large volume change while S has been harassed by dissolution and shuttling of the intermediate products of lithium polysulfides (Li₂Sₙ, n≥3).

Second, SEs provide better safety than that of oLEs. oLEs are highly flammable and prone to cause fires and explosions under abuse (such as overcharge and external heating). This is particularly important for widely implementing rechargeable batteries. In fact, battery safety has considerably hindered electrification in modern societies.

SEs can be divided into two categories: inorganic (i.e., iSEs) and polymeric (pSEs). An ideal SE for Li-based batteries should simultaneously meet multiple requirements, including high ionic conductivity close to that of oLEs (e.g., 10⁻⁴-10⁻³ S/cm at room temperature), high Li-ion transference number, low interfacial resistance, excellent thermal and electrochemical stability, and sufficient mechanical strength.

A large variety of iSEs have been studied, including oxides, sulfides, halides, and other materials. However, such materials generally face many challenges, such as mechanical degradation, brittleness, and interfacial stabilization and contact.

Compared to oLEs, pSEs have prominent advantages, such as low flammability; easy processability; and more tolerance to vibration, shock, and mechanical deformation. pSEs also provide better electrode/electrolyte interfacial contact as well as compatibility than that of iSEs.

To date, pSEs can be divided into three types, including solvent-free polymer electrolytes (SPEs), gel polymer electrolytes (GPEs), and composite polymer electrolytes (CPEs). Despite their classification, pSEs are still experiencing many difficulties in at least the following aspects: (1) relatively low ionic conductivities (it is still quite challenging to achieve an ionic conductivity of 10⁻³ S/cm for SPEs at room temperature); (2) poor interfaces; (3) low Li⁺ transference number; and (4) low electrochemical and thermal stability.

As such, a need exists for the development of improved energy storage device components, including pSEs, that have at least improved ionic conductivity, enhanced interfaces, high Li⁺ transference number, and high electrochemical and thermal stability. Numerous embodiments of the present disclosure aim to address the aforementioned need.

### Energy Storage Devices

In some embodiments, the present disclosure pertains to an energy storage device. In some embodiments, at least one component of the energy storage device is associated with a polymeric composition. In some embodiments, the polymeric composition includes at least one polymer. In some embodiments, the polymer includes, without limitation, a metal alkoxide-based polymer, a homopolymer of a metal alkoxide-based polymer, a heteropolymer of a metal alkoxide-based polymer, a thiolate-based polymer, a homopolymer of a thiolate-based polymer, a heteropolymer of a thiolate-based polymer, and a heteropolymer of a metal alkoxide-based polymer and a thiolate-based polymer. As set forth in more detail herein, the energy storage devices of the present disclosure can have numerous embodiments.

### Energy Storage Device

The energy storage devices of the present disclosure can be in various forms. For instance, in some embodiments, the energy storage devices of the present disclosure include a battery. In some embodiments, the battery includes, without limitation, a solid-state battery (i.e., a battery that includes a solid-state electrolyte), an alkali metal-based battery (i.e., a battery using an alkali metal (e.g., Li, Na, and/or K) as its anode), a lithium-ion based battery (i.e., a lithium-ion battery), and combinations thereof.

The polymeric compositions of the present disclosure can serve as various energy storage device components. For instance, in some embodiments, the polymeric composition is a component of a solid-state electrolyte. In some embodiments, the solid-state electrolyte includes a polymer electrolyte. In some embodiments, the polymer electrolyte includes, without limitation, solvent-free polymer electrolytes (SPEs), gel polymer electrolytes (GPEs), composite polymer electrolytes (CPEs), and combinations thereof.

In some embodiments, the solid-state electrolyte has an ionic conductivity of at least 10⁻⁴ S/cm at room temperature. In some embodiments, the solid-state electrolyte has an ionic conductivity of at least 10⁻³ S/cm at room temperature.

In some embodiments, the polymeric composition is a component of an electrode. In some embodiments, the polymeric composition is a coating on the electrode. In some embodiments, the electrode is an anode. In some embodiments, the electrode is a cathode.

### Polymeric Compositions

The energy storage devices of the present disclosure can include various polymeric compositions. For instance, in some embodiments, the polymeric composition includes a metal alkoxide-based polymer. In some embodiments, the metal alkoxide-based polymer includes the following formula:

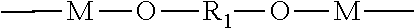

In some embodiments, the polymeric composition includes a thiolate-based polymer. In some embodiments, the thiolate-based polymer includes the following formula:

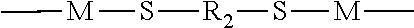

In some embodiments, M in each of the aforementioned formulas includes, without limitation, a metal, an alkali metal, Li, Na, K, Al, Ti, Zn, Zr, Hf, V, Mn, and combinations thereof. In some embodiments, M includes, without limitation, Li, Na, Al, K, and combinations thereof. In some embodiments, M includes Li. In some embodiments, M includes Al.

In some embodiments, R₁ and R₂ in each of the aforementioned formulas independently includes a carbon-containing compound. In some embodiments, the carbon-containing compound includes, without limitation, alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

The polymeric compositions of the present disclosure can be in various forms. For instance, in some embodiments, the polymeric compositions of the present disclosure are in the form of a plurality of stacked layers. In some embodiments, each layer includes at least one metal alkoxide-based polymer, at least one thiolate-based polymer, or combinations thereof. In some embodiments, the polymeric composition includes at least a first layer and a second layer.

In some embodiments, the first layer includes —Li—O—R₁—O—Li— and the second layer includes —Al—O—R₁—O—Al—. In some embodiments, the first layer includes —Li—O—R₁—O—Li— and the second layer includes —Zn—O—R₁—O—Zn—.

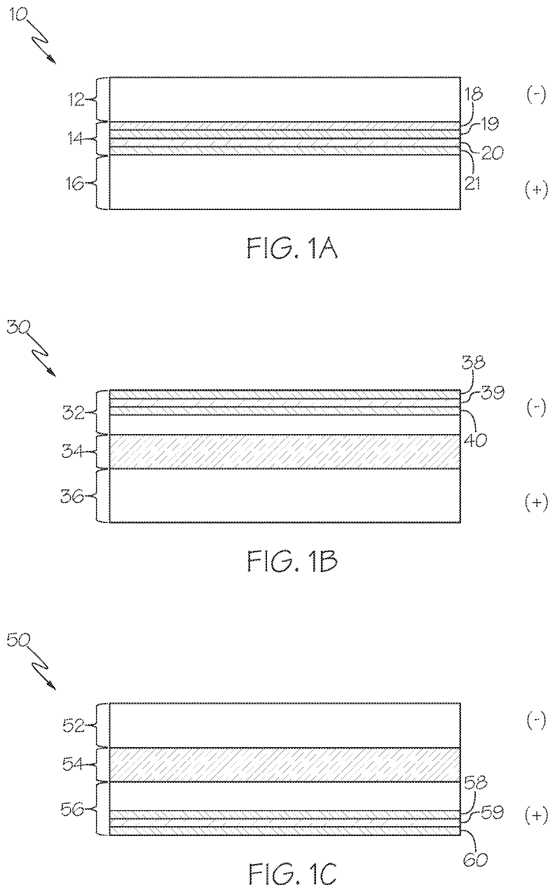

FIGS. 1A-1C provide specific examples of the energy storage devices of the present disclosure. As a first example, FIG. 1A illustrates solid-state battery 10, which includes anode 12, polymer electrolyte 14, and cathode 16. In this Example, the polymeric composition of the present disclosure is a component of polymer electrolyte 14. Additionally, the polymeric composition includes a plurality of stacked layers 18, 19, 20, and 21.

As a second example, FIG. 1B illustrates solid-state battery 30, which includes anode 32, polymer electrolyte 34, and cathode 36. In this Example, the polymeric composition of the present disclosure is a component of anode 32. Additionally, the polymeric composition includes a plurality of stacked layers 38, 39, and 40.

As a third example, FIG. 1C illustrates solid-state battery 50, which includes anode 52, polymer electrolyte 54, and cathode 56. In this Example, the polymeric composition of the present disclosure is a component of cathode 56. Additionally, the polymeric composition includes a plurality of stacked layers 58, 59, and 60.

### Methods of Making Energy Storage Devices

Additional embodiments of the present disclosure pertain to methods of making an energy storage device. In some embodiments, the methods of the present disclosure generally include a step of forming a polymeric composition. In some embodiments, the methods of the present disclosure also include a step of incorporating the polymeric composition as a component of the energy storage device. As set forth in more detail herein, the methods of the present disclosure can have numerous embodiments.

### Formation of Polymeric Compositions

Various methods may be utilized to form polymeric compositions. For instance, in some embodiments, polymeric compositions are formed by (1) combining at least one metal source with at least one hydroxyl group-containing organic precursor to form a metal alkoxide-based homopolymer or heteropolymer, (2) combining at least one metal source with at least one thiol group-containing organic precursor to form a thiolate-based homopolymer or heteropolymer, and/or (3) combining at least one metal source with at least one hydroxyl group-containing organic precursor and at least one thiol group-containing organic precursor to form a metal alkoxide-based and thiolate-based heteropolymer.

### Metal Sources

The methods of the present disclosure may utilize various metal sources. For instance, in some embodiments, the metal source includes, without limitation, an alkali metal source, a lithium (Li) metal source, a sodium (Na) metal source, a potassium (K) metal source, an aluminum (Al) metal source, a titanium (Ti) metal source, a zinc (Zn) metal source, a zirconium (Zr) metal source, a hafnium (Hf) metal source, a vanadium (V) metal source, a manganese (Mn) metal source, or combinations thereof.

In some embodiments, the metal source includes a lithium metal source. In some embodiments, the lithium metal source includes, without limitation, lithium tert-butoxide (LTB, LiO^{t}Bu), lithium hexamethyldisilazide (LiHMDS, Li(N(SiMe3)2)), lithium trimethylsilanolate (LiTMSO, LiOSiMe3), Li(thd) (thd=2,2,6,6-tetramethyl-3,5-heptanedionate), or combinations thereof.

In some embodiments, the metal source includes a sodium metal source. In some embodiments, the sodium metal source includes, without limitation, NaO^{t}Bu, NaTMSO, Na(thd), or combinations thereof.

In some embodiments, the metal source includes a potassium metal source. In some embodiments, the potassium metal source includes, without limitation, KO^{t}Bu, KTMSO, K(thd), or combinations thereof.

In some embodiments, the metal source includes an aluminum metal source. In some embodiments, the aluminum metal source includes, without limitation, trimethylaluminum (TMA), aluminum isoproxide (ATIP), or combinations thereof.

In some embodiments, the metal source includes a titanium metal source. In some embodiments, the titanium metal source includes, without limitation, titanium isoperoxide (TTIP), tetrakis(dimethylamido)titanium (TDMA-Ti), or combinations thereof.

In some embodiments, the metal source includes a zinc metal source. In some embodiments, the zine metal source includes, without limitation, diethylzinc (DEZ), zinc acetate, or combinations thereof.

In some embodiments, the metal source includes a zirconium metal source. In some embodiments, the zirconium metal source includes, without limitation, zirconium tetra-tert-butoxide (ZTB), tetrakis(dimethylamido)zirconium (TDMA-Zr), or combinations thereof.

In some embodiments, the metal source includes a hafnium metal source. In some embodiments, the hafnium metal source includes tetrakis(dimethylamido)hafnium (TDMA-Hf).

In some embodiments, the metal source includes a vanadium metal source. In some embodiments, the vanadium metal source includes tetrakis(ethylmethylamido)vanadium (TEMA-V).

In some embodiments, the metal source includes a manganese metal source. In some embodiments, the manganese metal source includes bis(ethylcyclopentadienyl)manganese (Mn(CpEt)₂).

### Hydroxyl Group-Containing Organic Precursors

In some embodiments, polymeric composition formation includes a step of combining at least one metal source with at least one hydroxyl group-containing organic precursor. Metal sources may be combined with various hydroxyl group-containing organic precursors. For instance, in some embodiments, the hydroxyl group-containing organic precursor includes, without limitation, diols, triols, polyols, hydroquinone (HQ), tetrafluorohydroquinone (FHQ), 1,4-benzenedicarboxylic acid (BDC), 2,6-naphthalene dicarboxylic acid (NDC), ethylene glycol (EG), 1,2-ethanediol (EDO), 1,4-butanediol (BDO), 1,6-hexanediole (HDO), fumaric acid (FC), 2,4-hexadiyene-1,6-diol (HDD), 1,2,4-trihydroxybenzene (THB), glycerol (GL), triethanolamine (TEA), lactic acid (LC), 2,2-bis(hydroxymethyl)-1,3-propanediole (BHMPD), alpha-thioglycerol (TGL), 1,2,4-butanetriol (BT), 1,2,5,6-hexanetriol (HT), 2-hydroxymethyl-1,3-propanediol (HMPD), 1-(4-nitrophenyl)glycerol (NPGL), and combinations thereof.

### Thiol Group-Containing Organic Precursors

In some embodiments, polymeric composition formation includes a step of combining at least one metal source with at least one thiol group-containing organic precursor. Metal sources may be combined with various thiol group-containing organic precursors. For instance, in some embodiments, the thiol group-containing organic precursor includes, without limitation, dithiols, trithiols, polythiols, 1,4-dithiothreitol (DTT), benezen-1,4-dithiol (BDT), biphenyl-4,4-dithiole (BPDT), p-terphenyl-4,4-dithiol (TPDT), 4,4-dimercaptostilebene (DMS), 4,4-bis(mercaptomethyl)biphenyl (BMMBP), 1,3,4-thiadiazole-2,5-dithiole (TDDT), dithioglycol (DTG), 1,3-propanedithiol (PDT), 1,4-butanedithiol (BDT), 2,2-(ethylenedioxy)diethanethiol (EDODET), pentaerythritol tetrakis(3-mercaptopropionate) (PETMP), trimethylolpropane tris(3-mercaptoproprionate) (TMPTMP), propane-1,2,3-trithiol (PTT), and combinations thereof.

### Combining Steps

Metal sources may be combined with hydroxyl group-containing organic precursors and/or thiol group-containing organic precursors in various manners. For instance, in some embodiments, the combining occurs by molecular layer deposition (MLD). Advantageously, MLD can accurately grow pure and hybrid polymers with an accuracy at the molecular level. MLD commonly relies on alternative self-limiting surface reactions to achieve materials growth in a layer-by-layer mode. The molecular-level accuracy is determined by the long chains of MLD organic precursors.

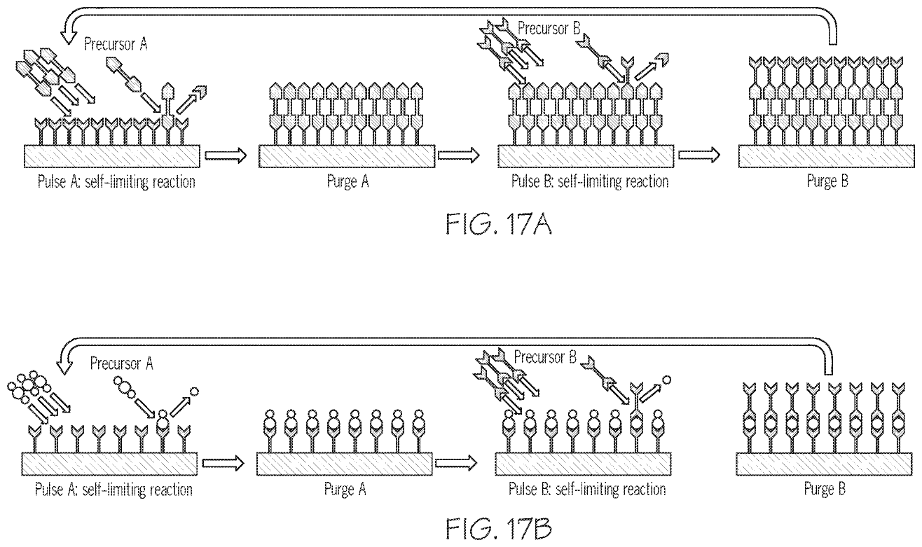

In some MLD embodiments illustrated in FIG. 17A for growing pure polymers, the molecules of a precursor A first react with the reactive sites of a substrate via a corresponding linking chemistry to add a molecular layer with new reactive sites on the substrate surface. Following a thorough purge A, the molecules of the precursor B react with the new reactive sites, thereby produce another molecular layer, and recover the surface back to the initial reactive groups. Another full purge B is performed to finish one MLD cycle. Through repeating the afore-discussed four steps, one can achieve the desired film thickness via MLD.

In some MLD embodiments illustrated in FIG. 17B, MLD also enables the growth of organic-inorganic hybrids by adopting a metal-based precursor and a polymeric precursor, such as metal alkoxide materials, in which diols can be used to couple with a metal precursor.

### Formed Polymeric Compositions

The methods of the present disclosure may be utilized to form various types of polymeric compositions. Suitable polymeric compositions were described supra and are incorporated herein by reference.

For instance, in some embodiments, the formed polymeric compositions include a metal alkoxide-based polymer. In some embodiments, the metal alkoxide-based polymer includes the following formula:

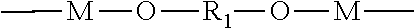

In some embodiments, the formed polymeric compositions include a thiolate-based polymer. In some embodiments, the thiolate-based polymer includes the following formula:

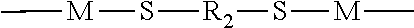

In some embodiments, M in each of the aforementioned formulas includes, without limitation, a metal, an alkali metal, Li, Na, K, Al, Ti, Zn, Zr, Hf, V. Mn, and combinations thereof. In some embodiments, M includes, without limitation, Li, Na, Al, K, and combinations thereof. In some embodiments. M includes Li. In some embodiments, M includes Al.

In some embodiments, R₁ and R₂ in each of the aforementioned formulas independently includes a carbon-containing compound. In some embodiments, the carbon-containing compound includes, without limitation, alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

The formed polymeric compositions can be in various forms. For instance, in some embodiments, a combining step may be repeated a plurality of times to form a layered polymeric composition. In some embodiments, the formed polymeric composition is in the form of a plurality of stacked layers. In some embodiments, each layer includes at least one metal alkoxide-based polymer, at least one thiolate-based polymer, or combinations thereof.

In some embodiments, the formed polymeric composition includes at least a first layer and a second layer. In some embodiments, the first layer includes —Li—O—R₁—O—Li— and the second layer includes —Al—O—R₁—O—Al—. In some embodiments, the first layer includes —Li—O—R₁—O—Li— and the second layer includes —Zn—O—R₁—O—Zn—.

Incorporation into Energy Storage Devices

Various methods may be utilized to incorporate the formed polymeric compositions of the present disclosure into energy storage devices. For instance, in some embodiments, the incorporation includes forming the polymeric composition on a component of the energy storage device. In some embodiments, the incorporation includes associating the formed polymeric composition with a component of the energy storage device.

The formed polymeric compositions of the present disclosure may be incorporated as various components of energy storage devices. For instance, in some embodiments, the component includes a solid-state electrolyte. In some embodiments, the solid-state electrolyte includes a polymer electrolyte. In some embodiments, the polymer electrolyte includes, without limitation, solvent-free polymer electrolytes (SPEs), gel polymer electrolytes (GPEs), composite polymer electrolytes (CPEs), and combinations thereof. In some embodiments, the solid-state electrolyte has an ionic conductivity of at least 10⁻⁴ S/cm at room temperature. In some embodiments, the solid-state electrolyte has an ionic conductivity of at least 10⁻³ S/cm at room temperature.

In some embodiments, the component includes an electrode. In some embodiments, the polymeric composition is incorporated as coating on the electrode. In some embodiments, the electrode is an anode. In some embodiments, the electrode is a cathode.

### Energy Storage Device

Polymeric compositions may be incorporated as components of various energy storage devices. For instance, in some embodiments, the energy storage device includes a battery. In some embodiments, the battery include, without limitation, a solid-state battery, an alkali metal-based battery, a lithium-ion based battery, and combinations thereof.

### Polymeric Compositions

Additional embodiments of the present disclosure pertain to polymeric compositions. Suitable polymeric compositions were described supra and are incorporated herein by reference.

For instance, in some embodiments, the polymeric composition includes at least one polymer. In some embodiments, the polymer includes, without limitation, a metal alkoxide-based polymer, a homopolymer of a metal alkoxide-based polymer, a heteropolymer of a metal alkoxide-based polymer, a thiolate-based polymer, a homopolymer of a thiolate-based polymer, a heteropolymer of a thiolate-based polymer, and a heteropolymer of a metal alkoxide-based polymer and a thiolate-based polymer.

In some embodiments, the polymeric composition includes a metal alkoxide-based polymer. In some embodiments, the metal alkoxide-based polymer includes the following formula:

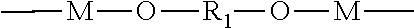

In some embodiments, the polymeric composition includes a thiolate-based polymer. In some embodiments, the thiolate-based polymer includes the following formula:

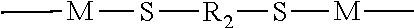

In some embodiments, M in each of the aforementioned formulas includes, without limitation, a metal, an alkali metal, Li, Na, K, Al, Ti, Zn, Zr, Hf, V, Mn, and combinations thereof. In some embodiments, M includes, without limitation, Li, Na, Al, K, and combinations thereof. In some embodiments. M includes Li. In some embodiments, M includes Al.

In some embodiments, R₁ and R₂ in each of the aforementioned formulas independently includes a carbon-containing compound. In some embodiments, the carbon-containing compound includes, without limitation, alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

The polymeric compositions of the present disclosure can be in various forms. For instance, in some embodiments, the polymeric compositions of the present disclosure are in the form of a plurality of stacked layers. In some embodiments, each layer includes at least one metal alkoxide-based polymer, at least one thiolate-based polymer, or combinations thereof. In some embodiments, the polymeric composition includes at least a first layer and a second layer. In some embodiments, the first layer includes —Li—O—R₁—O—Li— and the second layer includes —Al—O—R₁—O—Al—. In some embodiments, the first layer includes —Li—O—R₁—O—Li— and the second layer includes —Zn—O—R₁—O—Zn—.

### Methods of Forming Polymeric Compositions

Additional embodiments of the present disclosure pertain to methods of forming the polymeric compositions of the present disclosure. Suitable methods of forming polymeric compositions were described supra and are incorporated herein by reference.

For instance, in some embodiments, polymeric compositions are formed by (1) combining at least one metal source with at least one hydroxyl group-containing organic precursor to form a metal alkoxide-based homopolymer or heteropolymer, (2) combining at least one metal source with at least one thiol group-containing organic precursor to form a thiolate-based homopolymer or heteropolymer, and/or (3) combining at least one metal source with at least one hydroxyl group-containing organic precursor and at least one thiol group-containing organic precursor to form a metal alkoxide-based and thiolate-based heteropolymer.

### Metal Sources

The methods of the present disclosure may utilize various metal sources. For instance, in some embodiments, the metal source includes, without limitation, an alkali metal source, a lithium (Li) metal source, a sodium (Na) metal source, a potassium (K) metal source, an aluminum (Al) metal source, a titanium (Ti) metal source, a zinc (Zn) metal source, a zirconium (Zr) metal source, a hafnium (Hf) metal source, a vanadium (V) metal source, a manganese (Mn) metal source, or combinations thereof.

In some embodiments, the metal source includes a lithium metal source. In some embodiments, the lithium metal source includes, without limitation, lithium tert-butoxide (LTB, LiO^{t}Bu), lithium hexamethyldisilazide (LiHMDS, Li(N(SiMe3)2)), lithium trimethylsilanolate (LiTMSO, LiOSiMe3), Li(thd) (thd=2,2,6,6-tetramethyl-3,5-heptanedionate), or combinations thereof.

In some embodiments, the metal source includes a sodium metal source. In some embodiments, the sodium metal source includes, without limitation, NaO^{t}Bu, NaTMSO, Na(thd), or combinations thereof.

In some embodiments, the metal source includes a potassium metal source. In some embodiments, the potassium metal source includes, without limitation, KO^{t}Bu, KTMSO, K(thd), or combinations thereof.

In some embodiments, the metal source includes an aluminum metal source. In some embodiments, the aluminum metal source includes, without limitation, trimethylaluminum (TMA), aluminum isoproxide (ATIP), or combinations thereof.

In some embodiments, the metal source includes a titanium metal source. In some embodiments, the titanium metal source includes, without limitation, titanium isoperoxide (TTIP), tetrakis(dimethylamido)titanium (TDMA-Ti), or combinations thereof.

In some embodiments, the metal source includes a zinc metal source. In some embodiments, the zinc metal source includes, without limitation, diethylzinc (DEZ), zinc acetate, or combinations thereof.

In some embodiments, the metal source includes a zirconium metal source. In some embodiments, the zirconium metal source includes, without limitation, zirconium tetra-tert-butoxide (ZTB), tetrakis(dimethylamido)zirconium (TDMA-Zr), or combinations thereof.

In some embodiments, the metal source includes a hafnium metal source. In some embodiments, the hafnium metal source includes tetrakis(dimethylamido)hafnium (TDMA-Hf).

In some embodiments, the metal source includes a vanadium metal source. In some embodiments, the vanadium metal source includes tetrakis(ethylmethylamido)vanadium (TEMA-V).

In some embodiments, the metal source includes a manganese metal source. In some embodiments, the manganese metal source includes bis(ethylcyclopentadienyl)manganese (Mn(CpEt)₂).

### Hydroxyl Group-Containing Organic Precursors

In some embodiments, polymeric composition formation includes a step of combining at least one metal source with at least one hydroxyl group-containing organic precursor. Metal sources may be combined with various hydroxyl group-containing organic precursors. For instance, in some embodiments, the hydroxyl group-containing organic precursor includes, without limitation, diols, triols, polyols, hydroquinone (HQ), tetrafluorohydroquinone (FHQ), 1,4-benzenedicarboxylic acid (BDC), 2,6-naphthalene dicarboxylic acid (NDC), ethylene glycol (EG), 1,2-ethanediol (EDO), 1,4-butanediol (BDO), 1,6-hexanediole (HDO), fumaric acid (FC), 2,4-hexadiyene-1,6-diol (HDD), 1,2,4-trihydroxybenzene (THB), glycerol (GL), triethanolamine (TEA), lactic acid (LC), 2,2-bis(hydroxymethyl)-1,3-propanediole (BHMPD), alpha-thioglycerol (TGL), 1,2,4-butanetriol (BT), 1,2,5,6-hexanetriol (HT), 2-hydroxymethyl-1,3-propanediol (HMPD), 1-(4-nitrophenyl)glycerol (NPGL), and combinations thereof.

### Thiol Group-Containing Organic Precursors

In some embodiments, polymeric composition formation includes a step of combining at least one metal source with at least one thiol group-containing organic precursor. Metal sources may be combined with various thiol group-containing organic precursors. For instance, in some embodiments, the thiol group-containing organic precursor includes, without limitation, dithiols, trithiols, polythiols, 1,4-dithiothreitol (DTT), benezen-1,4-dithiol (BDT), biphenyl-4,4-dithiole (BPDT), p-terphenyl-4,4-dithiol (TPDT), 4,4-dimercaptostilebene (DMS), 4,4-bis(mercaptomethyl)biphenyl (BMMBP), 1,3,4-thiadiazole-2,5-dithiole (TDDT), dithioglycol (DTG), 1,3-propanedithiol (PDT), 1,4-butanedithiol (BDT), 2,2-(ethylenedioxy)diethanethiol (EDODET), pentaerythritol tetrakis(3-mercaptopropionate) (PETMP), trimethylolpropane tris(3-mercaptoproprionate) (TMPTMP), propane-1,2,3-trithiol (PTT), and combinations thereof.

### Combining Steps

Metal sources may be combined with hydroxyl group-containing organic precursors and/or thiol group-containing organic precursors in various manners. For instance, in some embodiments, the combining occurs by molecular layer deposition (MLD).

### Formed Polymeric Compositions

The methods of the present disclosure may be utilized to form various types of polymeric compositions. Suitable polymeric compositions were described supra and are incorporated herein by reference.

For instance, in some embodiments, the formed polymeric compositions include a metal alkoxide-based polymer. In some embodiments, the metal alkoxide-based polymer includes the following formula:

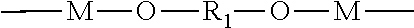

In some embodiments, the formed polymeric compositions include a thiolate-based polymer. In some embodiments, the thiolate-based polymer includes the following formula:

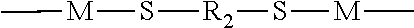

In some embodiments, M in each of the aforementioned formulas includes, without limitation, a metal, an alkali metal, Li, Na, K, Al, Ti, Zn, Zr, Hf, V, Mn, and combinations thereof. In some embodiments, M includes, without limitation, Li, Na, Al, K, and combinations thereof. In some embodiments, M includes Li. In some embodiments, M includes Al.

In some embodiments, R₁ and R₂ in each of the aforementioned formulas independently includes a carbon-containing compound. In some embodiments, the carbon-containing compound includes, without limitation, alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

The formed polymeric compositions can be in various forms. For instance, in some embodiments, a combining step may be repeated a plurality of times to form a layered polymeric composition. In some embodiments, the formed polymeric composition is in the form of a plurality of stacked layers. In some embodiments, each layer includes at least one metal alkoxide-based polymer, at least one thiolate-based polymer, or combinations thereof.

In some embodiments, the formed polymeric composition includes at least a first layer and a second layer. In some embodiments, the first layer includes —Li—O—R₁—O—Li— and the second layer includes —Al—O—R₁—O—Al—. In some embodiments, the first layer includes —Li—O—R₁—O—Li— and the second layer includes —Zn—O—R₁—O—Zn—.

### Additional Embodiments

Reference will now be made to more specific embodiments of the present disclosure and experimental results that provide support for such embodiments. However, applicant notes that the disclosure below is for illustrative purposes only and is not intended to limit the scope of the claimed subject matter in any way.

### Example 1. Preparation of Polymeric Alkali Metal Alkoxides and Thiolates

Polymeric alkali metal alkoxides and thiolates are hybrid polymers having carbon-containing backbones, i.e., —Li—O—R—O—Li— and —Li—S—R—S—Li—, respectively, where R is used in these molecular structures to represent the “Rest of the molecule”. R consists of a group of carbon and hydrogen atoms of any size. In this Example, Applicant has developed new processes for producing novel homopolymers of alkali metal alkoxides (homo-alkoxides) and thiolates (homo-thiolates) via molecular layer deposition (MLD). Furthermore, Applicant has developed tunable strategies to prepare copolymers of alkali metal alkoxides (co-alkoxides) and thiolates (co-thiolates) with varying properties through combining two or more different alkali metal homo-alkoxides and homo-thiolates, respectively. In addition, Applicant has developed tunable strategies to prepare alkali metal co-alkoxides through combining alkali metal homo-alkoxides with other metal homo-alkoxides or to produce alkali metal co-thiolates through combining alkali metal homo-thiolates with other metal thiolates.

These resultants alkoxides and thiolates can be further combined into alkali metal co-polymers. Moreover, the resultant alkali metal alkoxides and thiolates are promising polymer electrolytes, such as solid polymer electrolytes (SPEs), and surface coating in energy storage devices, such as lithium-ion batteries (LIBs) and alkali metal batteries (AMBs), enabling high ionic conductivity, high electronic insulation, and desirable mechanical, chemical, and electrochemical properties.

### Example 1.1. Alkali Metal Precursors

Alkali metal precursors are sources of alkali metals (i.e., Li, Na, and K) in MLD processes. They include lithium-containing precursors, sodium-containing precursors, potassium-containing precursors, and metal-containing precursors.

### Example 1.1.1. Lithium-Containing Precursors

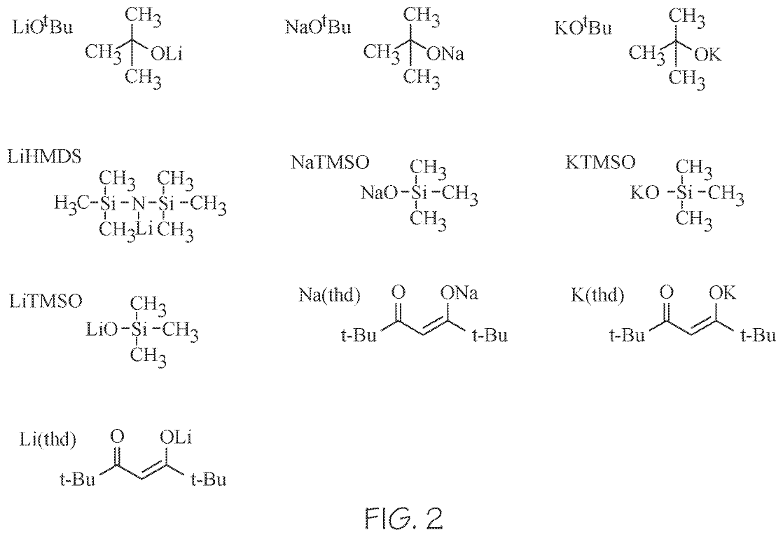

To produce polymeric lithium alkoxides and thiolates in this Example, there are four compounds usable as lithium-containing precursors, including lithium tert-butoxide (LTB, LiO^{t}Bu), lithium hexamethyldisilazide [LiHMDS, Li(N(SiMe₃)₂)], lithium trimethylsilanolate (LiTMSO, LiOSiMe₃), and Li(thd) (thd=2,2,6,6-tetramethyl-3,5-heptanedionate). These lithium-containing precursors are used as lithium sources in molecular layer deposition (MLD) processes of lithicone. Their molecular structures are shown in FIG. 2, in which t-Bu is tert-butyl, i.e., —C(CH₃)₃.

### Example 1.1.2. Sodium-Containing Precursors

To produce polymeric sodium alkoxides and thiolates in this Example, there are NaO^{t}Bu, NaTMSO, and Na(thd) as sodium-containing precursors (FIG. 2).

### Example 1.1.3. Potassium-Containing Precursors

To produce polymeric potassium alkoxides and thiolates in this Example, there are KO^{t}Bu, KTMSO, and K(thd) as potassium-containing precursors (FIG. 2).

### Example 1.1.4. Metal-Containing Precursors

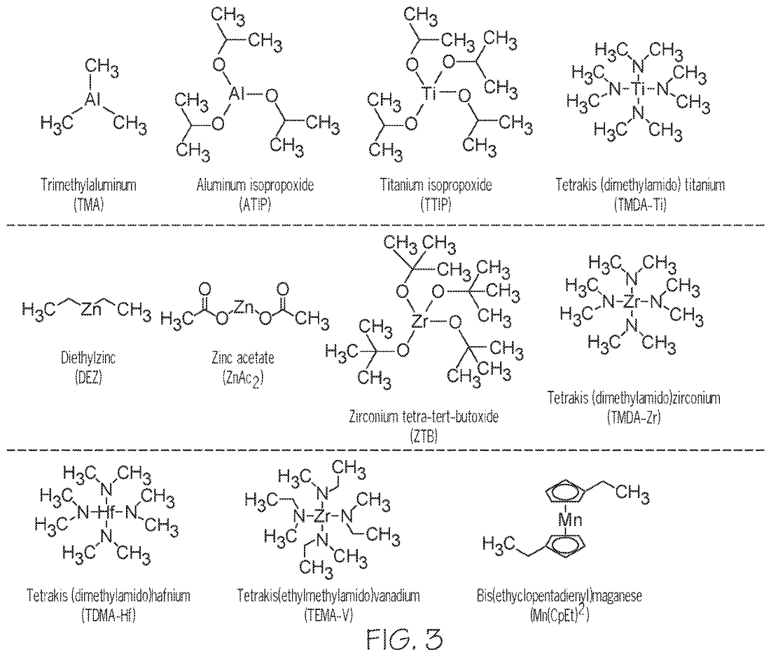

To produce polymeric metal alkoxides and thiolates (other than alkali metals) in this Example, some commonly used metal precursors are listed in FIG. 3.

### Example 1.2. Organic Precursors

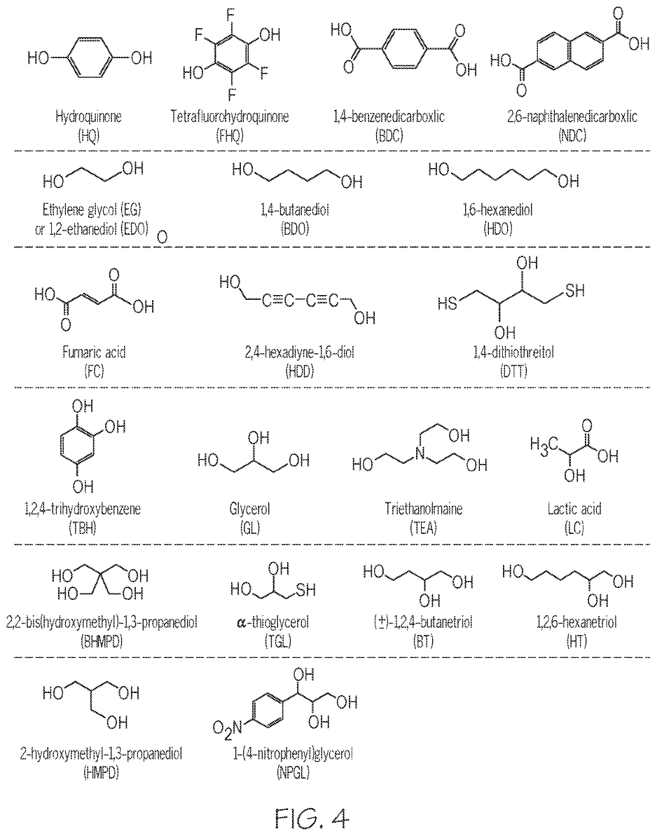

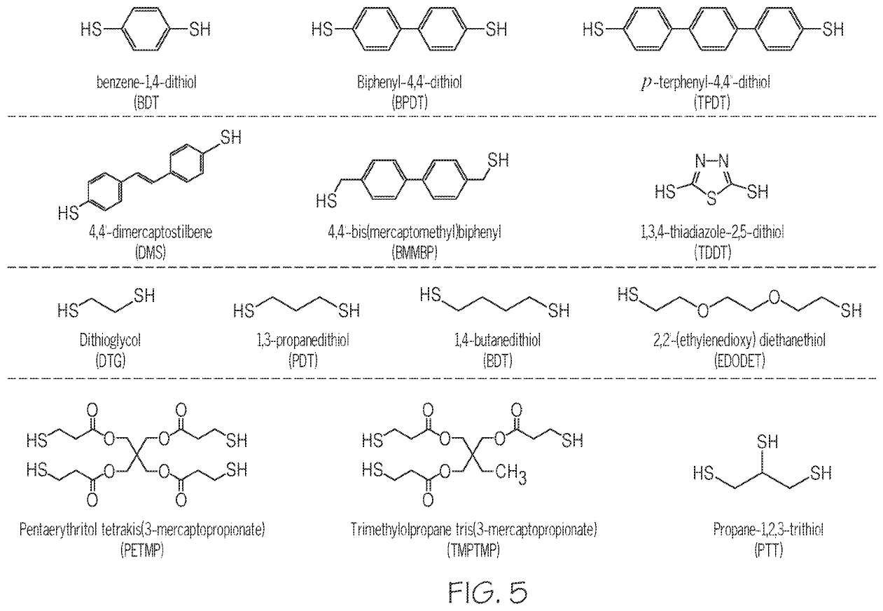

To couple with the above-stated lithium-containing precursors and provide various polymeric chains or backbones of alkoxides and thiolates, in this Example there are two types of organic precursors developed, featuring their hydroxyl (—OH) groups (FIG. 4) and thiol (—SH) groups (FIG. 5).

### Example 1.3. MLD Processes for Homo-alkoxides and Homo-thiolates

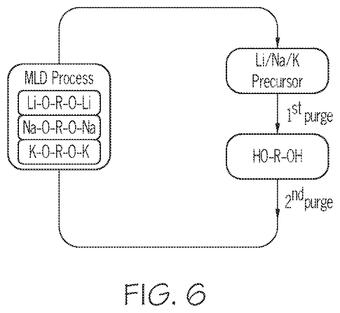

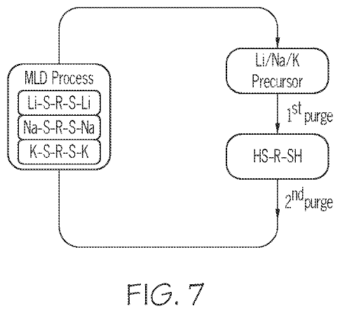

Using one of alkali metal precursors in FIG. 2 to couple with any organic precursors in FIG. 4, there are a variety of alkali metal homo-alkoxides produced with a repeatable unit of —Li/Na/K—O—R—O—K/Na/Li—, as illustrated in FIG. 6. Similarly, using one of alkali metal precursors in FIG. 2 to couple with any organic precursors in FIG. 5, there are many alkali metal homo-thiolates prepared with a repeatable unit of —Li/Na/K—S—R—S—K/Na/Li—, as illustrated in FIG. 7. FIGS. 17A-17B provide a general scheme for an MLD process.

### Example 1.4. Super-MLD Processes for Polymeric Co-alkoxides and Co-thiolates

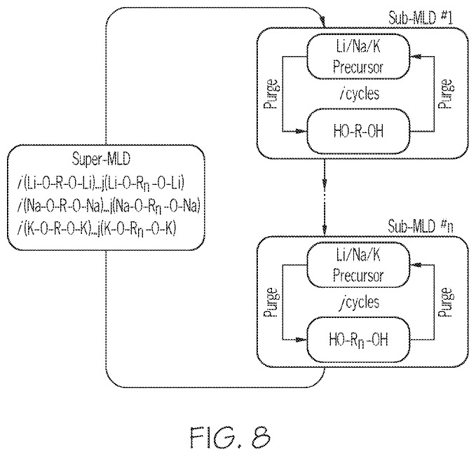

Applicant has applied several strategies to develop polymeric co-alkoxides and co-thiolates for tuning their properties. One strategy (illustrated in FIG. 8) is to combine two or more individual MLD (sub-MLD) processes of alkali metal homo-alkoxides into a super-MLD process for growing alkali metal co-alkoxides, in which the cycles of the sub-MLD processes are adjustable. In doing so, the resultant alkali metal co-alkoxides are tunable to achieve desirable properties.

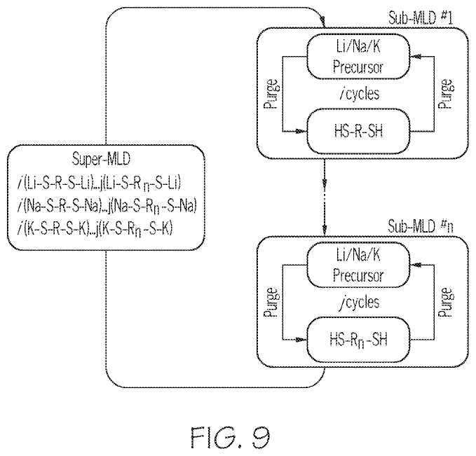

Another strategy (illustrated in FIG. 9) is to combine two or more individual MLD (sub-MLD) processes of alkali metal homo-thiolates into a super-MLD process for growing alkali metal co-thiolates, in which the cycles of the sub-MLD processes are adjustable. In doing so, the resultant alkali metal co-thiolates are tunable to achieve desirable properties.

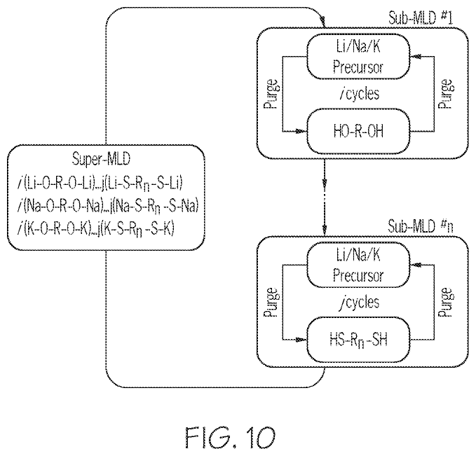

A further strategy (as illustrated in FIG. 10) is to combine two or more individual MLD (sub-MLD) processes of alkali metal homo-alkoxides and homo-thiolates into a super-MLD process for growing alkali metal co-alkoxide-thiolates, in which the cycles of the sub-MLD processes are adjustable. In doing so, the resultant alkali metal co-alkoxide-thiolates are tunable to achieve desirable properties.

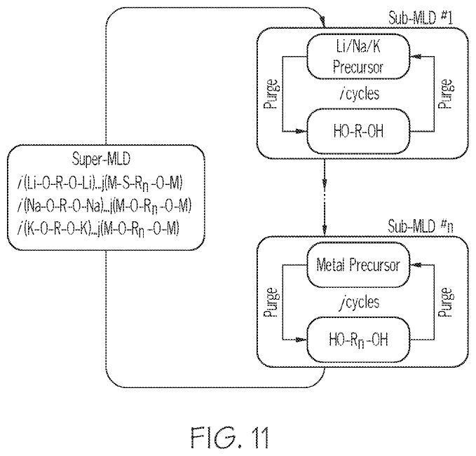

Another strategy (as illustrated in FIG. 11) is to combine two or more individual MLD (sub-MLD) processes of alkali metal homo-alkoxides and metal (M) homo-alkoxides into a super-MLD process for growing metal-doped alkali metal co-alkoxides, in which the cycles of the sub-MLD processes are adjustable. In doing so, the resultant metal-doped alkali metal co-alkoxides are tunable to achieve desirable properties.

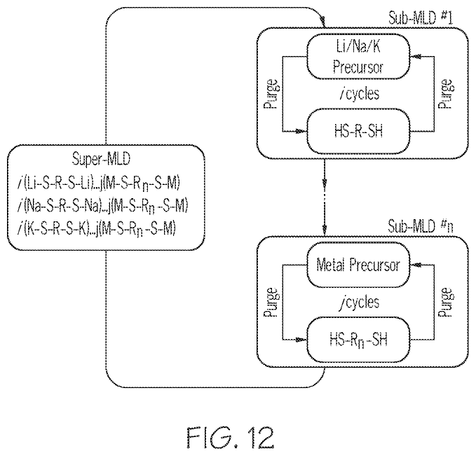

An alternative strategy (as illustrated in FIG. 12) is to combine two or more individual MLD (sub-MLD) processes of alkali metal homo-thiolates and metal (M) homo-thiolates into a super-MLD process for growing metal-doped alkali metal co-thiolates, in which the cycles of the sub-MLD processes are adjustable. In doing so, the resultant metal-doped alkali metal co-thiolates are tunable to achieve desirable properties.

### Example 1.5. Proof of Concept

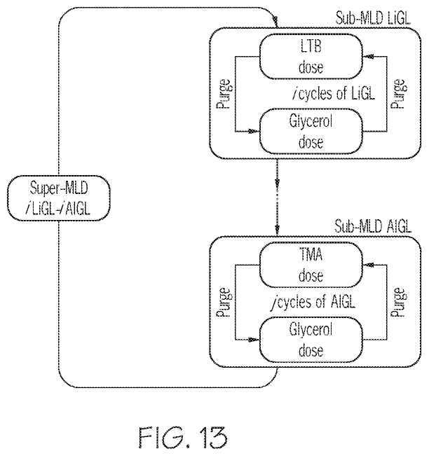

Through combining one sub-MLD process of LiGL and one sub-MLD of AlGL, as illustrated in FIG. 13, Applicant developed Al-doped LiGL co-alkoxides of iLiGL-jAlGL, where i and j are sub-cycles of the two sub-MLD processes, respectively. In this super-MLD process, LTB is lithium tert-butoxide, TMA is trimethylaluminum, and GL is glycerol.

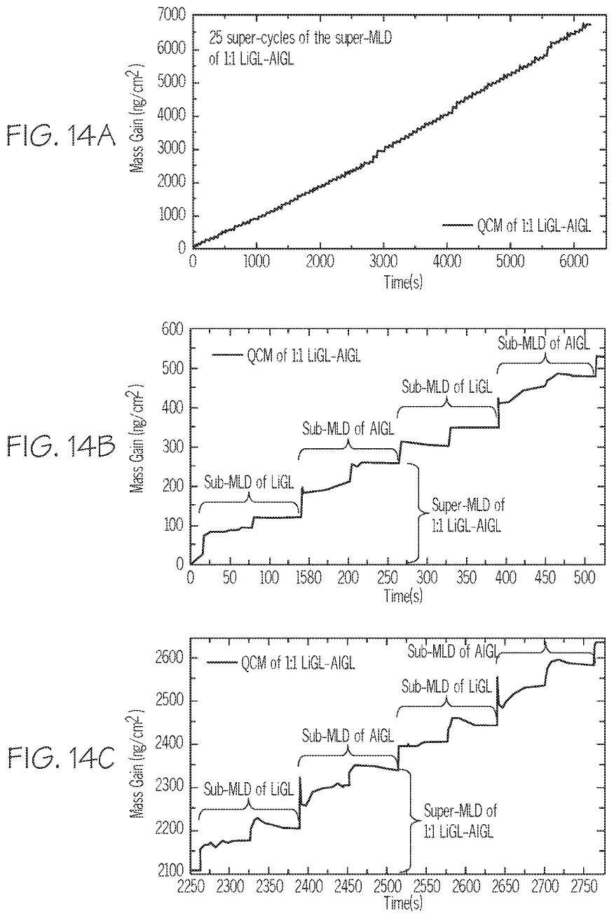

FIG. 14A shows a linear growth of the super-MLD of 1:1 LiGL-AlGL in 25 super-cycles, measured by a quartz crystal microbalance (QCM). FIGS. 14B and 14C show the enlarged growth sections at the very beginning and the middle growth period, respectively. They reveal repeatable mass gains after each super-cycle.

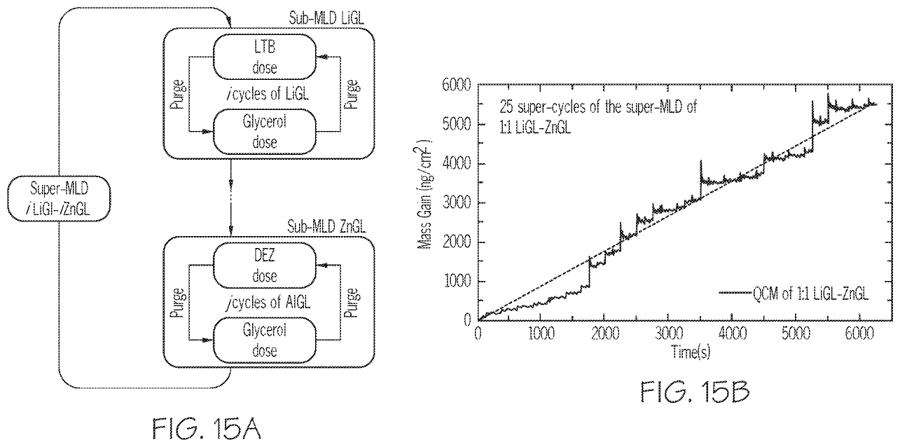

Through combining one sub-MLD process of LiGL and one sub-MLD of ZnGL, as illustrated in FIG. 15A, Applicant developed Zn-doped LiGL co-alkoxides of iLiGL-jAlGL, where i and j are sub-cycles of the two sub-MLD processes, respectively. In this super-MLD process, LTB is lithium tert-butoxide, DEZ is diethylzinc, and GL is glycerol. FIG. 15B shows a linear growth of the super-MLD of 1:1 LiGL-ZnGL in 25 super-cycles, measured by a quartz crystal microbalance (QCM). The red dashed line in FIG. 15B guides the linear growth.

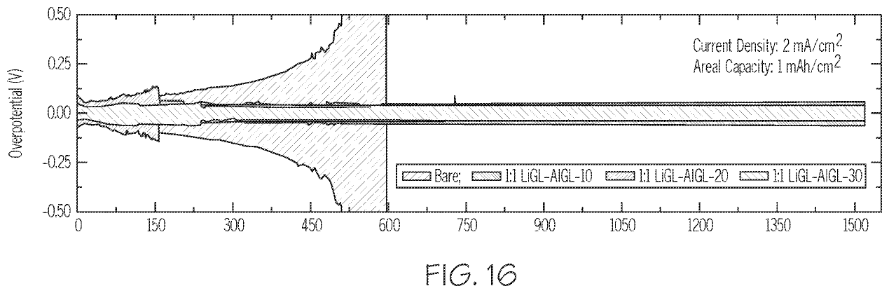

The developed 1:1 LiGL-AlGL coating was further verified being effective to protect Li anodes from corrosion for long-term cyclability in Li/Li symmetric cells. As illustrated in FIG. 16, the Li anodes coated with 10, 20, and 30 super-cycles of 1:1 LiGL-AlGL (i.e., 1:1 LiGL-AlGL-10/20/30) could realize long-term cyclability while the bare Li/Li cell fail in 600 cycles. This implies that the 1:1 LiGL-AlGL co-alkoxide has superior properties such as ionic conductivity, chemical, and electrochemical stability, and good insulation electronically.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

What is claimed is:

1. An energy storage device, wherein at least one component of the energy storage device is associated with a polymeric composition, wherein the polymeric composition comprises at least one polymer selected from the group consisting of a metal alkoxide-based polymer, a homopolymer of a metal alkoxide-based polymer, a heteropolymer of a metal alkoxide-based polymer, a thiolate-based polymer, a homopolymer of a thiolate-based polymer, a heteropolymer of a thiolate-based polymer, and a heteropolymer of a metal alkoxide-based polymer and a thiolate-based polymer.

2. The energy storage device of claim 1, wherein the energy storage device comprises a battery selected from the group consisting of a solid-state battery, an alkali metal-based battery, a lithium-ion based battery, and combinations thereof.

3. (canceled)

4. The energy storage device of claim 1, wherein the polymeric composition is a component of a solid-state electrolyte of the energy storage device, wherein the solid-state electrolyte comprises a polymer electrolyte.

5. (canceled)

6. The energy storage device of claim 1, wherein the polymeric composition is a component of an electrode of the energy storage device, wherein the electrode is an anode or a cathode.

7-8. (canceled)

9. The energy storage device of claim 1, wherein the polymeric composition comprises a metal alkoxide-based polymer, wherein the metal alkoxide-based polymer comprises the following formula: 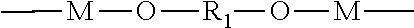
wherein M is selected from the group consisting of a metal, an alkali metal, Li, Na, K, Al, Ti, Zn, Zr, Hf, V, Mn, and combinations thereof, and
wherein R₁ comprises a carbon-containing compound.

10. The energy storage device of claim 1, wherein the polymeric composition comprises a thiolate-based polymer, wherein the thiolate-based polymer comprises the following formula: 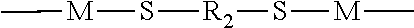
wherein M is selected from the group consisting of a metal, an alkali metal, Li, Na, K, Al, Ti, Zn, Zr, Hf, V, Mn, and combinations thereof, and
wherein R₂ comprises a carbon-containing compound.

11. The energy storage device of claim 9, wherein M is selected from the group consisting of Li, Na, Al, K, and combinations thereof.

12. The energy storage device of claim 9, wherein the carbon-containing compound is selected from the group consisting of alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

13. The energy storage device of claim 1, wherein the polymeric composition is in the form of a plurality of stacked layers, wherein each layer comprises at least one metal alkoxide-based polymer, at least one thiolate-based polymer, or combinations thereof.

14-15. (canceled)

16. The energy storage device of claim 13, wherein the polymeric composition comprises at least a first layer and a second layer, wherein the first layer comprises —Li—O—R₁—O—Li— and wherein the second layer comprises —Al—O—R₁—O—Al—, wherein R₁ comprises a carbon-containing compound.

17. The energy storage device of claim 13, wherein the polymeric composition comprises at least a first layer and a second layer, wherein the first layer comprises —Li—O—R₁—O—Li— and wherein the second layer comprises —Zn—O—R₁—O—Zn—, wherein R₁ comprises a carbon-containing compound.

18. A method of making an energy storage device, said method comprising:
forming a polymeric composition, wherein the forming comprises at least one step of:
combining at least one metal source with at least one hydroxyl group-containing organic precursor to form a metal alkoxide-based homopolymer or heteropolymer,
combining at least one metal source with at least one thiol group-containing organic precursor to form a thiolate-based homopolymer or heteropolymer,
combining at least one metal source with at least one hydroxyl group-containing organic precursor and at least one thiol group-containing organic precursor to form a metal alkoxide-based and thiolate-based heteropolymer, or
combinations thereof, and
incorporating the polymeric composition as a component of the energy storage device.

19. The method of claim 18, wherein the at least one metal source is selected from the group consisting of an alkali metal source, a lithium (Li) metal source, a sodium (Na) metal source, a potassium (K) metal source, an aluminum (Al) metal source, a titanium (Ti) metal source, a zinc (Zn) metal source, a zirconium (Zr) metal source, a hafnium (Hf) metal source, a vanadium (V) metal source, a manganese (Mn) metal source, or combinations thereof.

20. The method of claim 18, wherein the combining comprises combining at least one metal source with at least one hydroxyl group-containing organic precursor, wherein the at least one hydroxyl group-containing organic precursor is selected from the group consisting of diols, triols, polyols, hydroquinone (HQ), tetrafluorohydroquinone (FHQ), 1,4-benzenedicarboxylic acid (BDC), 2,6-naphthalene dicarboxylic acid (NDC), ethylene glycol (EG), 1,2-ethanediol (EDO), 1,4-butanediol (BDO), 1,6-hexanediole (HDO), fumaric acid (FC), 2,4-hexadiyene-1,6-diol (HDD), 1,2,4-trihydroxybenzene (THB), glycerol (GL), triethanolamine (TEA), lactic acid (LC), 2,2-bis(hydroxymethyl)-1,3-propanediole (BHMPD), alpha-thioglycerol (TGL), 1,2,4-butanetriol (BT), 1,2,5,6-hexanetriol (HT), 2-hydroxymethyl-1,3-propanediol (HMPD), 1-(4-nitrophenyl)glycerol (NPGL), and combinations thereof.

21. (canceled)

22. The method of claim 18, wherein the combining comprises combining at least one metal source with at least one thiol group-containing organic precursor, wherein the at least one thiol group-containing organic precursor is selected from the group consisting of dithiols, trithiols, polythiols, 1,4-dithiothreitol (DTT), benezen-1,4-dithiol (BDT), biphenyl-4,4-dithiole (BPDT), p-terphenyl-4,4-dithiol (TPDT), 4,4-dimercaptostilebene (DMS), 4,4-bis(mercaptomethyl)biphenyl (BMMBP), 1,3,4-thiadiazole-2,5-dithiole (TDDT), dithioglycol (DTG), 1,3-propanedithiol (PDT), 1,4-butanedithiol (BDT), 2,2-(ethylenedioxy)diethanethiol (EDODET), pentaerythritol tetrakis(3-mercaptopropionate) (PETMP), trimethylolpropane tris(3-mercaptoproprionate) (TMPTMP), propane-1,2,3-trithiol (PTT), and combinations thereof.

23. (canceled)

24. The method of claim 18, wherein the combining comprises molecular layer deposition (MLD).

25. The method of claim 18, wherein the polymeric composition comprises a metal alkoxide-based polymer, wherein the metal alkoxide-based polymer comprises the following formula: 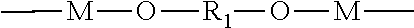
wherein M is selected from the group consisting of a metal, an alkali metal, Li, Na, K, Al, Ti, Zn, Zr, Hf, V, Mn, and combinations thereof, and
wherein R₁ comprises a carbon-containing compound.

26. The method of claim 18, wherein the polymeric composition comprises a thiolate-based polymer, wherein the thiolate-based polymer comprises the following formula: 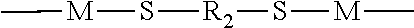
wherein M is selected from the group consisting of a metal, an alkali metal, Li, Na, K, Al, Ti, Zn, Zr, Hf, V, Mn, and combinations thereof, and
wherein R₂ comprises a carbon-containing compound.

27. The method of claim 25, wherein M is selected from the group consisting of Li, Na, Al, K, and combinations thereof.

28. The method of claim 25, wherein the carbon-containing compound is selected from the group consisting of alkyl groups, alkene groups, alkyne groups, carbonyl groups, carboxylic acid groups, alcohol groups, ether groups, phenol groups, amido groups, amide groups, amine groups, methyl groups, ethyl groups, isopropyl groups, isobutyl groups, glycerol groups, aromatic groups, phenyl groups, benzene groups, quinone groups, and combinations thereof.

29. The method of claim 18, wherein the combining is repeated a plurality of times to form a layered polymeric composition, wherein the polymeric composition is in the form of a plurality of stacked layers, wherein each layer comprises at least one metal alkoxide-based polymer, at least one thiolate-based polymer, or combinations thereof.

30-31. (canceled)

32. The method of claim 29, wherein the polymeric composition comprises at least a first layer and a second layer.

33. The method of claim 29, wherein the polymeric composition comprises at least a first layer and a second layer, wherein the first layer comprises —Li—O—R₁—O—Li—, and wherein the second layer comprises —Al—O—R₁—O—Al—, wherein R₁ comprises a carbon-containing compound.

34. The method of claim 29, wherein the polymeric composition comprises at least a first layer and a second layer, wherein the first layer comprises —Li—O—R₁—O—Li— and wherein the second layer comprises —Zn—O—R₁—O—Zn—, wherein R₁ comprises a carbon-containing compound.

35. The method of claim 18, wherein the incorporating comprises forming the polymeric composition on a component of the energy storage device.

36. The method of claim 18, wherein the incorporating comprises associating the formed polymeric composition with a component of the energy storage device.

37. The method of claim 35, wherein the component comprises a solid-state electrolyte, and wherein the solid-state electrolyte comprises a polymer electrolyte.

38. (canceled)

39. The method of claim 35, wherein the component comprises an electrode, wherein the electrode is an anode or a cathode.

40-41. (canceled)

42. The method of claim 18, wherein the energy storage device comprises a battery selected from the group consisting of a solid-state battery, an alkali metal-based battery, a lithium-ion based battery, and combinations thereof.

43-70. (canceled)
